(19) United States
(12) Patent Application Publication
(10) Pub. No.: US 2023/0259757 A1
(43) Pub. Date: Aug. 17, 2023

(54) TIERED INPUT STRUCTURES FOR MACHINE LEARNING MODELS

(71) Applicant: PAYPAL, INC., San Jose, CA (US)

(72) Inventors: Itay Margolin, Pardesiya (IL); Matan Marudi, Or Yehuda (IL)

(21) Appl. No.: 17/673,377

(22) Filed: Feb. 16, 2022

(51) Int. Cl. G06N 3/08; G06Q 20/40

(52) U.S. Cl. CPC G06N 3/08; G06Q 20/4016

(57) ABSTRACT

Methods and systems for providing a machine learning model that can perform predictions based on incomplete input values are presented. The machine learning model includes multiple input layers of input nodes, where input nodes from different input layers can be connected with each other. Based on the connections among the input nodes, certain input values can be inferred from other input values. When a request is received, it is determined which input values are available and which input values are missing. Based on which input values are available, the machine learning model is modified by masking a subset of connections among nodes in the input layers. The modified machine learning model is then configured to infer the missing input values from the available input values, and to provide an output based on the available input values and the inferred input values. The request is processed based on the output.

### BACKGROUND

The present specification generally relates to machine learning models, and more specifically to, improving performance accuracy of machine learning models when only partial inputs are available according to various embodiments.

### RELATED ART

Machine learning models have been widely used to perform predictions for various reasons. For example, machine learning models may be used in classifying data (e.g., determining whether a transaction is a legitimate transaction or a fraudulent transaction). To construct a machine learning model, a set of input features are identified. Training data that includes attribute values corresponding to the set of input features and labels corresponding to pre-determined prediction outcomes may be provided to train the machine learning model. Based on the training data and labels, the machine learning model may learn patterns associated with the training data, and provide predictions based on the learned patterns. For example, new data (e.g., transaction data associated with a new transaction) that corresponds to the set of input features may be provided to the machine learning model. The machine learning model may perform a prediction for the new data based on the learned patters from the training data.

While machine learning models are effective in learning patterns and making predictions, they are dependent on the availability and the quality of input data provided to the machine learning models. Conventionally, in order to obtain a prediction (or an accurate prediction) from a machine learning model, a full set of input data corresponding to the pre-determined set of input features typically needs to be obtained and provided to the machine learning model. However, due to a variety of factors, such as network traffic, availability of various server systems that store data associated with the input data, etc., different input data may become available at different times. When the prediction is requested to be provided in real-time (e.g., within a predetermined threshold of time such as 1 second, 3 seconds, 5 seconds, etc. from the request), some of the input data may not be available in time, e.g., within a certain time window or constraint, to perform a real-time prediction. In this situation, either the quality of the prediction or the prediction experience would suffer. Thus, there is a need for improving the performance accuracy of a machine learning model when only partial input data is available.

### BRIEF DESCRIPTION OF THE FIGURES

FIG. 1 is a block diagram illustrating a networked system according to an embodiment of the present disclosure;

FIG. 2 illustrates an exemplary artificial neural network according to an embodiment of the present disclosure;

FIG. 3A-3E illustrates an artificial neural network that can perform predictions based on partial input data according to an embodiment of the present disclosure;

FIG. 4 is a block diagram illustrating a risk analysis module according to an embodiment of the present disclosure;

FIG. 5 is a flowchart showing a process of generating a machine learning model that can perform predictions based on partial input data according to an embodiment of the present disclosure;

FIG. 6 is a flowchart showing a process of using a machine learning model to provide a prediction output based on partial input data according to an embodiment of the present disclosure;

FIG. 7 is a flowchart showing a process of verifying a machine learning model's performance in inferring missing input data according to an embodiment of the present disclosure; and

FIG. 8 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing a machine learning model that can perform predictions based on incomplete or partial input data (e.g., not all data that would be available within a time window), for the prediction. In some embodiments, the machine learning model may be implemented as an artificial neural network. An artificial neural network usually includes an input layer, one or more hidden layers, and an output layer. Each of the layers may include one or more nodes. For example, the input layer of an artificial neural network may include nodes that represent a set of input features for the machine learning model. As discussed herein, a set of input features may be determined at the time when the machine learning model is constructed. The set of input features may be determined to be relevant in making a prediction by the machine learning model. For example, if the machine learning model is configured to predict whether a transaction request is a legitimate transaction request or a fraudulent transaction request, the set of input features may include an input feature associated with an Internet Protocol (IP) address of a device that initiates the transaction request, another input feature associated with a time when the transaction request is received, another input feature associated with an average transaction amount previously conducted by a user who initiated the transaction request, another input feature associated with a physical location of the device that initiates the transaction request, another input feature associated with a credit of the user who initiated the transaction request, and possibly other input features.

Each input node in the input layer of the artificial neural network may correspond to a distinct input feature. Thus, each of the input nodes in the input layers may accept a data value that corresponds to the corresponding input feature. Each of the input nodes may be connected to one or more hidden nodes in the first hidden layer of the artificial neural network. The hidden nodes in the hidden layers are hidden as they are not exposed to users of the machine learning model. From a user's perspective, only the input nodes of the input layer and the output node of the output layer are visible. The nodes in the hidden layer may be configured to obtain one or more input values from one or more input nodes, perform one or more mathematical operations on the one or more input values to generate an intermediate value (also referred to as a “representation”), and provide the intermediate value to one or more nodes in the next layer (which can be another hidden layer or the output layer). The output layer may include an output node that is configured to receive one or more intermediate values from one or more hidden nodes in a hidden layer, and generate an output value from the one or more intermediate values.

Conventionally, all of the input nodes are implemented within a single input layer, and each input node is only connected to one or more nodes in a hidden layer, but not to another input node. Input values corresponding to all of the set of input features have to be provided to the machine learning model before the machine learning model can perform a prediction. As discussed herein, different input values may be available at different times, and not all of the input values may become available within a certain time constraint or window. Using the set of input features associated with transaction requests discussed above as an example, retrieval of the input features associated with attributes of the device that initiated the transaction request (e.g., the IP address of the device, the physical location of the device, etc.) may depend on the processing speed and connectivity of the device. Retrieval of the input features associated with the average transaction amount of the user who initiated the transaction request may depend on network conditions between the server that hosts the machine learning model and the data storages that store the transaction data of the user, and the processing speed and load of the server that performs the calculation. Retrieval of the input features associated with credit data of the user may depend on a response time of a third-party server associated with a credit bureau. As such, different input data may become available to the machine learning machine at different times. The machine learning model may be used to predict a risk of the transaction request (e.g., a likelihood that the transaction request is associated with a fraudulent transaction). A transaction processing system may process the transaction request based on the risk. For example, the transaction processing system may authorize the transaction request and may perform a function (e.g., logging the user into an account, providing data access to the user, perform a payment transaction, etc.) when the risk is below a threshold, and may deny the transaction request when the risk is above the threshold.

In order to obtain an accurate risk prediction for the transaction request, the transaction processing system may wait until all of the input data become available before obtaining a prediction from the machine learning. However, since the transaction processing system is usually required to process the transaction request in real-time (e.g., within a time threshold such as a few seconds from receiving the transaction request) to ensure a positive customer experience, the transaction processing system may impose a time constraint for obtaining a prediction from the machine learning model. In some situations, due to delay of obtaining certain input data caused by degraded network conditions and/or processing conditions, some of the input data may not be available within the time constraint. When not all of the input data corresponding to the set of input features is available by the time a prediction is needed, the transaction processing system may either wait for all of the input data becomes available (which may extend beyond the required time constraint) before obtaining the prediction from the machine learning model, or using default data values (instead of actual data values associated with the transaction request) for the input features that are not yet available.

If the transaction processing system waits for all of the input data to become available, the customer experience may suffer, as the processing of the transaction request may be delayed. On the other hand, if the transaction processing system uses default data values for the input features that are not yet available, the accuracy of the prediction may suffer. As such, according to various embodiments of the disclosure, a risk analysis system may configure a machine learning model according to a neural network architecture that enables the machine learning model to provide predictions more accurately than conventional machine learning models based on incomplete input values. The neural network architecture according to various embodiments of the disclosure differs from conventional artificial neural networks in multiple ways. First, unlike conventional artificial neural networks that include only a single input layer, the neural network architecture of some embodiments may provide multiple input layers for a machine learning model. Each of the input layers may include input nodes that correspond to a subset of the input features associated with the machine learning model. Second, input nodes of each input layer may be connected to input nodes of another input layer. The connections among the input nodes across different input layers enable the machine learning model to learn how to infer (or impute) an input value from another input value, such that a missing input value from an incomplete set of input data may be inferred from an input value that is available to the machine learning model. Third, the connections among input nodes may be dynamically modified (e.g., selectively masked or removed) based on availability of input data while performing predictions.

To construct a machine learning model using the neural network architecture according to various embodiments of the disclosure, the risk analysis system may determine a number of input layers for the machine learning model. The risk analysis system may analyze attributes associated with how input data corresponding to the set of input features were received in the past, and may determine multiple tiers of input features based on the analysis. For example, the risk analysis system may determine the multiple tiers of input features based on a timeframe when input data corresponding to the input features can be obtained by the risk analysis system. In one example, the risk analysis system may determine three tiers of input features, wherein a first tier includes input features that are available within a first time threshold (e.g., within 0.5 seconds) most of the time (e.g., at least 95% of the time, at least 99% of the time, etc.), where a second tier includes input features that are available within a second time threshold (e.g., within 1 second) most of the time (e.g., at least 95% of the time, at least 99% of the time, etc.), and where a third tier includes the remaining input features. While three tiers of input features are used to illustrate the inventive concept in this example, any other number of tiers of input features (two or more) can be used without departing from the spirit of this disclosure.

Once the different tiers of input features are determined, the risk analysis system may configure a machine learning model (an artificial neural network) to include multiple input layers that correspond to the different tiers of input features. Thus, in the example where three tiers of input features are determined, the risk analysis system may configure the machine learning model to include three input layers. Each input layer may correspond to a distinct tier of input features, and may include input nodes that correspond to the input features within the corresponding tier. Thus, a first input layer may include input nodes that correspond to the input features in the first tier of input features, a second input layer may include input nodes that correspond to the input features in the second tier of input features, and a third input layer may include input nodes that correspond to the input features in the third tier of input features. Unlike conventional artificial neural networks in which input nodes are connected only to nodes in a hidden layer, the machine learning model configured by the risk analysis system according to various embodiments of the disclosure may include input nodes that connect to one another. Specifically, input nodes of each input layer may be connected to other input nodes in one or more preceding input layers and/or one or more succeeding input layers. For example, an input node in the first input layer may be connected to one or more input nodes in the second input layer and/or to one or more input nodes in the third input layer.

The connections among the input nodes enable the machine learning model configured by the risk analysis system to be trained to infer (or impute) one input value from one or more other input values. For example, when a first input node representing a first input feature is connected to a second input node representing a second input feature, the machine learning model may be trained to infer an input value corresponding to the second input feature based on another input value corresponding to the first input feature. Since the first input layer includes input nodes that represents the first tier of input features (e.g., features that would be obtained the fastest), the input values corresponding to the first tier of input features may be used by the machine learning model to infer (e.g., impute or predict) input values corresponding to input features in the second tier and/or the third tier. With sufficient training data, the machine learning model may learn to infer input features in the second tier and/or the third tier accurately (e.g., within a desired accuracy threshold) based on the first tier of input features. The input nodes from the different input layers may also be connected to one or more nodes in a hidden layer of the machine learning model, such that the machine learning model may perform additional inferences based on the entire set of input features to produce an output value. This way, even with an incomplete set of input values, the machine learning model can still provide accurate predictions because the machine learning model is trained to infer the missing input values to provide the prediction output.

During the training phase, the risk analysis system may use different training data sets to train the machine learning model. The training data sets may include historical data. For example, each training data set may include transaction data associated with a previously conducted transaction. Since the transaction was conducted in the past, a complete set of input values corresponding to the entire set of input features is available to the risk analysis system. In some embodiments, the risk analysis system may use the complete sets of data values to train the machine learning model to predict outcomes based on the complete sets of data values. When the complete set of data values is provided to the machine learning model, the risk analysis system may modify the machine learning model by removing (or masking) the connections among the input nodes, since no inference of input values is needed in this training scenario.

In some embodiments, in addition to training the machine learning model using complete sets of data values, the risk analysis system may select different subsets of the training data sets to train the machine learning model. In other words, the risk analysis system may also train the machine learning model using incomplete sets of data values. For example, after obtaining a training data set corresponding to a complete set of input features associated with the machine learning model, the risk analysis system may select one or more different subsets of the training data set for training the machine learning model. From the training data set, the risk analysis system may use a subset of input values that corresponds to the first and second tiers of input features to train the machine learning model. In this scenario, the risk analysis system may modify the machine learning model to remove (or mask) the connections between the input nodes of the first input layer and the input nodes of the second input layers (since there is no need to infer input values corresponding to the second tier of input features).

The risk analysis system may also use another subset of input values that corresponds to only the first tier of input features to train the machine learning model. In this scenario, the risk analysis system may not modify the machine learning model as it is necessary to infer input values of both the second tier and third tier of input features. In some embodiments, the risk analysis system may also use other subsets of input values to train the machine learning model. For example, the risk analysis system may select different input values corresponding to the second tier and the third tier of input features (e.g., selecting two out of five input values corresponding to the second tier of input features and selecting one out of five input values corresponding to the third tier of input features). The risk analysis system may combine the selected input values corresponding to the second and third tiers of input features with the input values corresponding to the first tier of input features to train the machine learning model. Based on which input values from the second tier and/or the third tier of input features are selected, the risk analysis system may modify the machine learning model before the training. For example, the risk analysis system may remove connections between the input nodes of the selected input features to other input nodes since there is no need to infer the input values corresponding to the selected input features.

The risk analysis system may continuously select different subsets of each training data set, modify the machine learning model based on the selected input values, and train the machine learning model. Based on training the machine learning model using a combination of complete sets of input values and different incomplete sets of input values, the machine learning model may be trained to not only predict an outcome using complete sets of input values, but also inferring missing input values based on an available subset of input values.

After configuring and training the machine learning model using this improved neural network architecture, the machine learning model is ready for performing predictions based on complete or incomplete input data values. For example, when a request for performing a prediction is received, the risk analysis system may attempt to retrieve input data values that are associated with the request for the machine learning model. In one example where the request is for predicting whether a transaction request is associated with a fraudulent transaction, the risk analysis system may attempt to retrieve (or request for) transaction attribute values associated with the transaction request that can be used as input data values for the machine learning model for predicting a likelihood that that the transaction request is associated with a fraudulent transaction. The transaction attribute values that the risk analysis system attempts to retrieve may include device attributes associated with a user device that initiated the request (e.g., an IP address of the user device, a physical location of the user device, a hardware and/or software configuration of the device, etc.), user attributes associated with a user that initiated the request (e.g., a user profile, transaction history associated with the user, etc.), and third-party data associated with the user (e.g., a credit report associated with the user, etc.). Since these transaction attribute values are obtained from different sources (e.g., from the user device, from an internal source such as a database system associated with the risk analysis system, from an external server such as a third-party credit bureau server, etc.), after transmitting data requests for such transaction attribute values to the different sources, the risk analysis system may receive the transaction attribute values at different times.

As discussed herein, the risk analysis system may be required to provide a prediction outcome within a time constraint. As such, according to various embodiments of the disclosure, the risk analysis system may determine a cutoff time after receiving the request before using the machine learning model to perform the prediction. The cutoff time may vary based on different factors, including, but not limited to amount, location, type of goods, time of day, and/or day of year of the transaction request. Since the input values may become available at different times and sometimes it is unpredictable how long some of the attribute values may become available, the risk analysis system may not obtain input values corresponding to the complete set of input features before the cutoff time. At the cutoff time, the risk analysis system may determine which input values are available (which may not correspond to the complete set of input features). Based on the available input values, the risk analysis system may dynamically modify the machine learning model to accommodate the available input values (or to accommodate the missing input values). For example, the risk analysis system may modify the machine learning model by removing (or masking) connections between input nodes where corresponding input values are available. The risk analysis system may then provide the available input values to the modified machine learning model. The modified machine learning model may infer the missing input values based on the available input values, and compute a prediction outcome based on the available input values and the inferred input values. The risk analysis system may then process the transaction request based on the prediction outcome, or provide the prediction outcome to another system for processing a transaction request.

In some embodiments, the risk analysis system may also verify the machine learning model's performance in inferring missing input data before using the predicted outcome to process the transaction request. For example, the risk analysis system may generate a first outcome using all of the available input data. The risk analysis system may then generate a second outcome by providing only a subset of the available input data corresponding to the first input layer to the machine learning model, forcing the machine learning model to infer all of the input values corresponding to the second and third input layers (including those that are actually available to the risk analysis system). The risk analysis system may then compare the first outcome and the second outcome. The risk analysis system may verify a good prediction performance from the machine learning model when the first and second outcomes are similar (e.g., within a threshold deviation), and may use either the first outcome, the second outcome, or a merged value calculated from the first and second outcomes to process the transaction request. On the other hand, the risk analysis system may determine that the machine learning model does not have a desired level of accuracy in inferring input values when the first outcome and the second outcome differ by more than the threshold deviation. The risk analysis system may increase a risk based on that determination. Alternatively, the risk analysis system may wait for another time period such that one or more additional input values may become available, and may use the machine learning model to perform the prediction again based on the newly available input values.

Thus, using the neural network architecture according to various embodiments of the disclosure to configure and train the machine learning model, the risk analysis system may use the machine learning model to perform more accurate predictions than conventional machine learning models based on incomplete input values. Specifically, the risk analysis system may dynamically modify the machine learning model based on the types of input values that are available (and the types of input values that are missing) such that the machine learning model may be configured to infer the missing input values from the available input values for the prediction process.

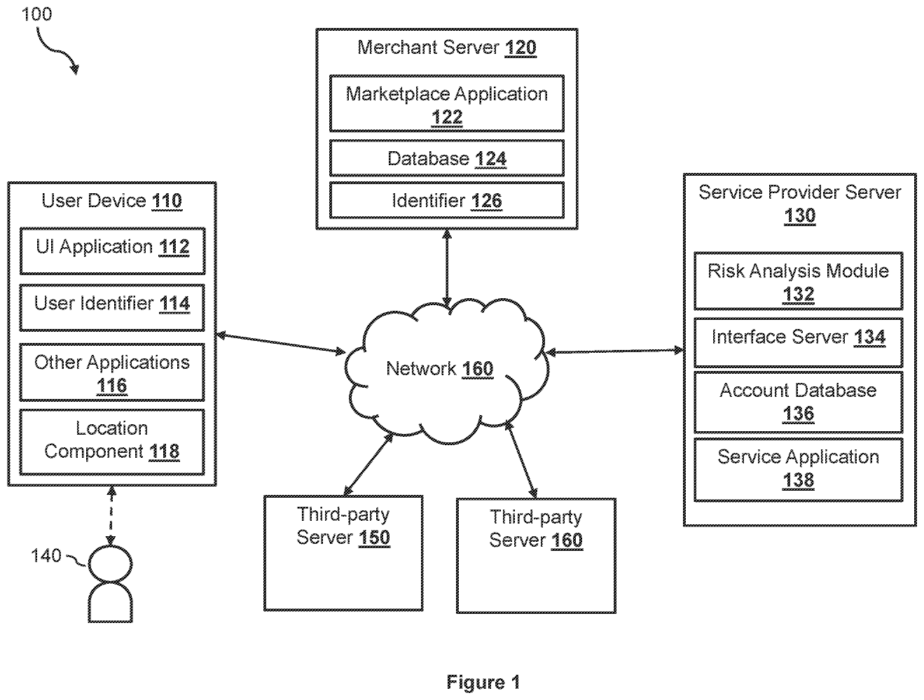

FIG. 1 illustrates a networked system 100 according to one embodiment of the disclosure within which the risk analysis system may be implemented. The networked system 100 includes a service provider server 130, a merchant server 120, a user device 110, and third-party servers 150 and 160 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to log in to a user account to conduct account services or conduct financial transactions (e.g., account transfers or payments) with the service provider server 130. Similarly, a merchant associated with the merchant server 120 may use the merchant server 120 to log in to a merchant account to conduct account services or conduct financial transactions (e.g., payment transactions) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser), which may be utilized by the user 140 to conduct transactions (e.g., shopping, purchasing, bidding, etc.) with the service provider server 130 over the network 160. In one aspect, purchase expenses may be directly and/or automatically debited from an account related to the user 140 via the user interface application 112.

In one implementation, the user interface application 112 includes a software program, such as a graphical user interface (GUI), executable by a processor that is configured to interface and communicate with the service provider server 130 via the network 160. In another implementation, the user interface application 112 includes a browser module that provides a network interface to browse information available over the network 160. For example, the user interface application 112 may be implemented, in part, as a web browser to view information available over the network 160.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. The identifier 114 may include one or more attributes related to the user 140 of the user device 110, such as personal information related to the user (e.g., one or more user names, passwords, photograph images, biometric IDs, addresses, phone numbers, social security number, etc.) and banking information and/or funding sources (e.g., one or more banking institutions, credit card issuers, user account numbers, security data and information, etc.). In various implementations, the identifier 114 may be passed with a user login request to the service provider server 130 via the network 160, and the identifier 114 may be used by the service provider server 130 to associate the user with a particular user account maintained by the service provider server 130.

In various implementations, the user 140 is able to input data and information into an input component (e.g., a keyboard) of the user device 110 to provide user information associated with a transaction request, such as a login request, a data access request, a fund transfer request, or other types of requests. The user information may include user identification information.

The user device 110, in various embodiments, includes a location component 118 configured to determine, track, monitor, and/or provide an instant geographical location of the user device 110. In one implementation, the geographical location may include GPS coordinates, zip-code information, area-code information, street address information, and/or various other generally known types of location information. In one example, the location information may be directly entered into the user device 110 by the user via a user input component, such as a keyboard, touch display, and/or voice recognition microphone. In another example, the location information may be automatically obtained and/or provided by the user device 110 via an internal or external monitoring component that utilizes a global positioning system (GPS), which uses satellite-based positioning, and/or assisted GPS (A-GPS), which uses cell tower information to improve reliability and accuracy of GPS-based positioning. In other embodiments, the location information may be automatically obtained without the use of GPS. In some instances, cell signals or wireless signals are used. For example, location information may be obtained by checking in using the user device 110 via a check-in device at a location, such as a beacon. This helps to save battery life and to allow for better indoor location where GPS typically does not work.

Even though only one user device 110 is shown in FIG. 1, it has been contemplated that one or more user devices (each similar to user device 110) may be communicatively coupled with the service provider server 130 via the network 160 within the system 100.

The merchant server 120, in various embodiments, may be maintained by a business entity (or in some cases, by a partner of a business entity that processes transactions on behalf of business entity). Examples of business entities include merchant sites, resource information sites, utility sites, real estate management sites, social networking sites, etc., which offer various items for purchase and process payments for the purchases. The merchant server 120 may include a merchant database 124 for identifying available items, which may be made available to the user device 110 for viewing and purchase by the user.

The merchant server 122, in one embodiment, may include a marketplace application 122, which may be configured to provide information over the network 160 to the user interface application 112 of the user device 110. For example, the user 140 of the user device 110 may interact with the marketplace application 122 through the user interface application 112 over the network 160 to search and view various items available for purchase in the merchant database 124.

The merchant server 120, in one embodiment, may include at least one merchant identifier 126, which may be included as part of the one or more items made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

A merchant may also use the merchant server 120 to communicate with the service provider server 130 over the network 160. For example, the merchant may use the merchant server 120 to communicate with the service provider server 130 in the course of various services offered by the service provider to a merchant, such as payment intermediary between customers of the merchant and the merchant itself. For example, the merchant server 120 may use an application programming interface (API) that allows it to offer sale of goods or services in which customers are allowed to make payment through the service provider server 130, while the user 140 may have an account with the service provider server 130 that allows the user 140 to use the service provider server 130 for making payments to merchants that allow use of authentication, authorization, and payment services of the service provider as a payment intermediary. The merchant may also have an account with the service provider server 130. Even though only one merchant server 120 is shown in FIG. 1, it has been contemplated that one or more merchant servers (each similar to merchant server 120) may be communicatively coupled with the service provider server 130 and the user device 110 via the network 160 in the system 100.

The service provider server 130, in one embodiment, may be maintained by a transaction processing entity or an online service provider, which may provide processing for electronic transactions between the user 140 of user device 110 and one or more merchants. As such, the service provider server 130 may include a service application 138, which may be adapted to interact with the user device 110 and/or the merchant server 120 over the network 160 to facilitate the searching, selection, purchase, payment of items, and/or other services offered by the service provider server 130. In one example, the service provider server 130 may be provided by PayPal®, Inc, of San Jose, Calif., USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities. In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also include other electronic pages associated with the different services (e.g., electronic transaction services, etc.) offered by the service provider server 130. As a result, a user (e.g., the user 140 or a merchant associated with the merchant server 120, etc.) may submit various transaction requests (e.g., requests to access a user account associated with the user, requests to access various services offered by the service provider server 130, etc.), by generating HTTP requests directed at the service provider server 130.

The service provider server 130, in one embodiment, may be configured to maintain one or more user accounts and merchant accounts in an account database 136, each of which may be associated with a profile and may include account information associated with one or more individual users (e.g., the user 140 associated with user device 110) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server includes a risk analysis module 132 that implements the risk analysis system as disclosed herein. The risk analysis module 132 may be configured to determine whether to authorize or deny an incoming request from the user device 110 or from the merchant server 120. The request may be a log-in request, a fund transfer request, a request for adding an additional funding source, or other types of requests associated with the variety of services offered by the service provider server 130. As such, when a new request is received at the service provider server 130 (e.g., by the interface 134), the risk analysis module 132 may analyze (or evaluate) the request and determine whether the request is possibly an unauthorized/fraudulent request based on information available to the risk analysis module 132. In some embodiments, the risk analysis module 132 may use a machine learning model to analyze and evaluate the request. For example, the risk analysis module 132 may provide the available information to the machine learning model to obtain a prediction outcome. The prediction outcome may indicate a likelihood that the transaction request is a fraudulent request. In one particular example, the prediction outcome may include a percentage that indicates the likelihood that the transaction request is a fraudulent request. The risk analysis module 132 may transmit an indication of whether the request is possibly an unauthorized/fraudulent request to the web server 134 and/or the service application 138 such that the web server 134 and/or the service application 138 may process (e.g., approve or deny) the request based on the indication. The risk analysis module 132 may also transmit the indication to the device that initiated the request.

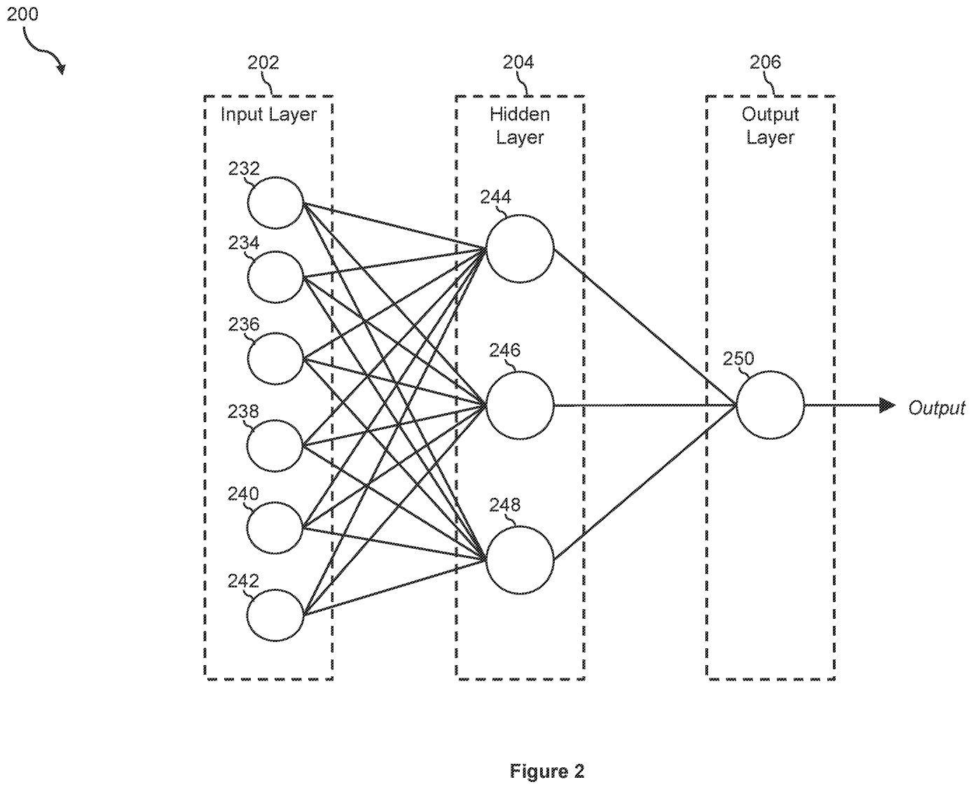

FIG. 2 illustrates an artificial neural network 200 that can be used for predicting a likelihood of whether a transaction request is associated with a fraudulent transaction. As shown, the artificial neural network 200 includes three layers—an input layer 202, a hidden layer 204, and an output layer 206. Each of the layers 202, 204, and 206 may include one or more nodes. For example, the input layer 202 includes nodes 232-842, the hidden layer 204 includes nodes 244-248, and the output layer 206 includes a node 250. In this example, each node in a layer is connected to every node in an adjacent layer. For example, the node 232 in the input layer 202 is connected to all of the nodes 244-248 in the hidden layer 204. Similarly, the node 244 in the hidden layer is connected to all of the nodes 232-242 in the input layer 202 and the node 250 in the output layer 206. Although only one hidden layer is shown for the artificial neural network 200, it has been contemplated that the artificial neural network 200 may include as many hidden layers as necessary.

In this example, the artificial neural network 200 is configured to receive a set of input values and produces an output value. Each node in the input layer 202 may correspond to a distinct input value (e.g., corresponding to a distinct input feature). For example, the node 232 may correspond to an IP address of a user device used to submit the transaction request, the node 234 may correspond to an average amount associated with past transactions conducted by a user, and the node 236 may correspond to a credit score of the user.

In some embodiments, each of the nodes 244-248 in the hidden layer 204 generates a representation, which may include a mathematical computation (or algorithm) that produces a value based on the input values received from the nodes 232-242. The mathematical computation may include assigning different weights to each of the data values received from the nodes 232-242. The weights determined for each node may become parameters to the artificial neural network 200. The nodes 244-248 may include different algorithms and/or different weights assigned to the data variables from the nodes 232-242 such that the nodes 244-248 may produce different values based on the same input values received from the nodes 232-242. In some embodiments, the weights that are initially assigned to the features (or input values) for each of the nodes 244-248 may be randomly generated (e.g., using a computer randomizer). The values generated by the nodes 244-248 may be used by the nodes 250 in the output layer 206 to produce an output value for the artificial neural network 200. In some embodiments, the output value produced by the artificial neural network 200 may indicate whether the transaction request associated with the input values provided to the nodes 232-242 in the input layer 202 is a fraudulent transaction.

The artificial neural network 200 may be trained by using historical transaction data (training data) associated with transactions and labels that indicate whether the transactions are fraudulent transactions. By providing training data to the artificial neural network 200, the nodes 244-248 in the hidden layer 204 may be trained (adjusted) such that an optimal output (accurate prediction of whether a transaction request is associated with a fraudulent transaction) is produced in the output layer 206 based on the training data.

By continuously providing different sets of training data, and penalizing the artificial neural network 200 when prediction output of the artificial neural network 200 is incorrect, the artificial neural network 200 (and specifically, the representations of the nodes in the hidden layer 804) may be trained (adjusted) to improve its performance in producing more accurate fraudulent transaction predictions over time. Adjusting the artificial neural network 200 may include adjusting the weights associated with each node in the hidden layer 204.

A machine learning model that is configured according to the artificial neural network 200 may be trained to produce relatively accurate predictions (e.g., 90% correct, 95% correct, etc.) when it is trained with sufficient training data. However, a drawback of such an implementation is that it requires all of the input values corresponding to the nodes 232-242 of the input layer 202 in order to make an accurate prediction. It is because the nodes 232-242 of the input layer 202 are included in a single input layer, which are only connected to nodes in the hidden layer 204. With incomplete input values (e.g., one or more of the input values corresponding to the nodes 232-242 of the input layer 202 are missing), the artificial neural network 200 may not be able to provide a prediction at all or may perform poorly, such as 50% or 60% correct (e.g., when using empty or default values corresponding to the missing input values).

As such, according to various embodiments of the disclosure, the risk analysis module 132 may implement and generate a machine learning model according to the neural network architecture as disclosed herein such that the machine learning model is capable to perform accurate predictions with incomplete input values.

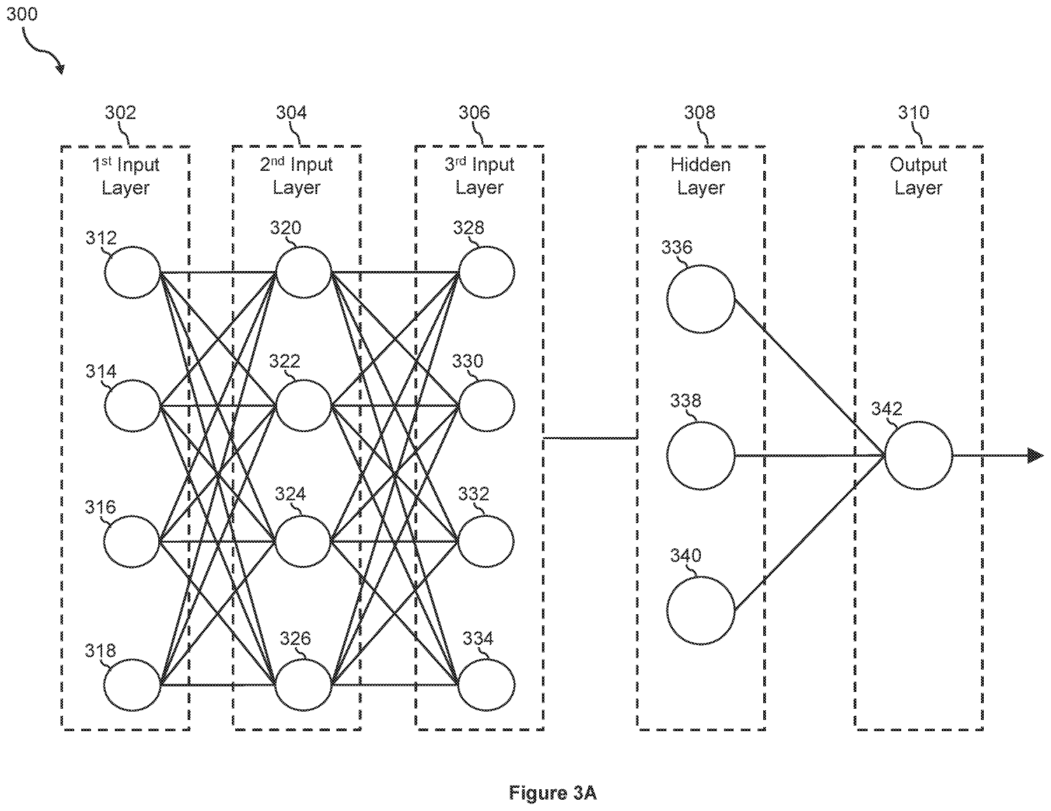

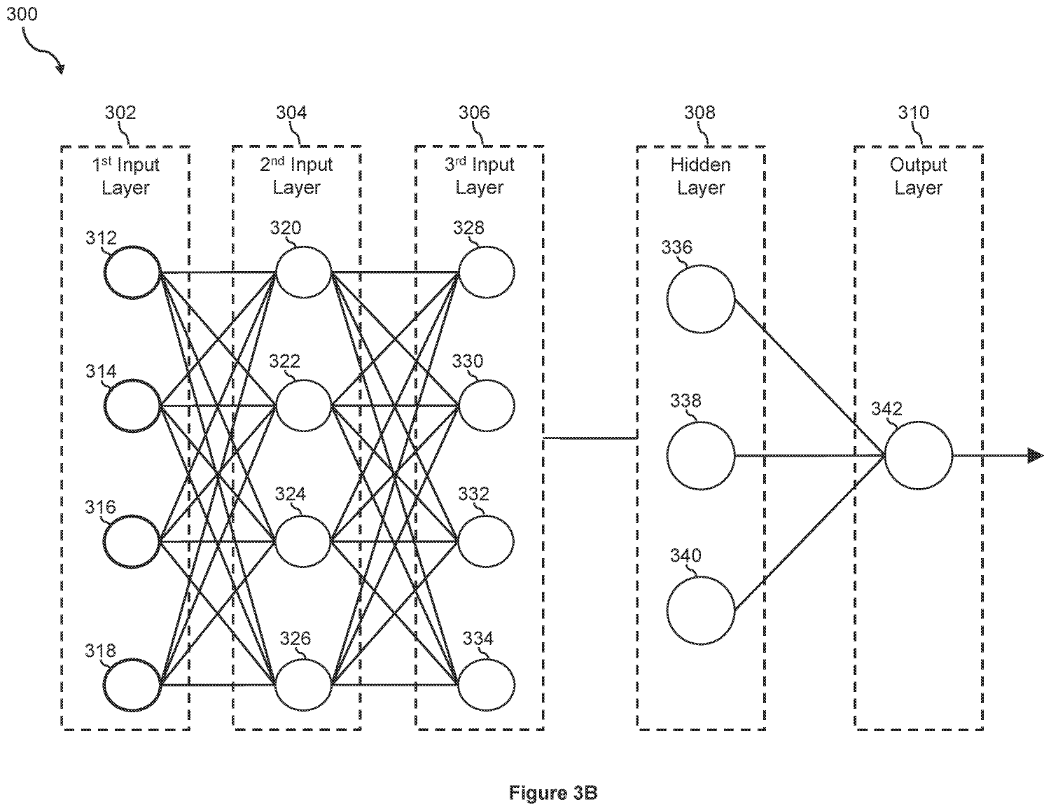

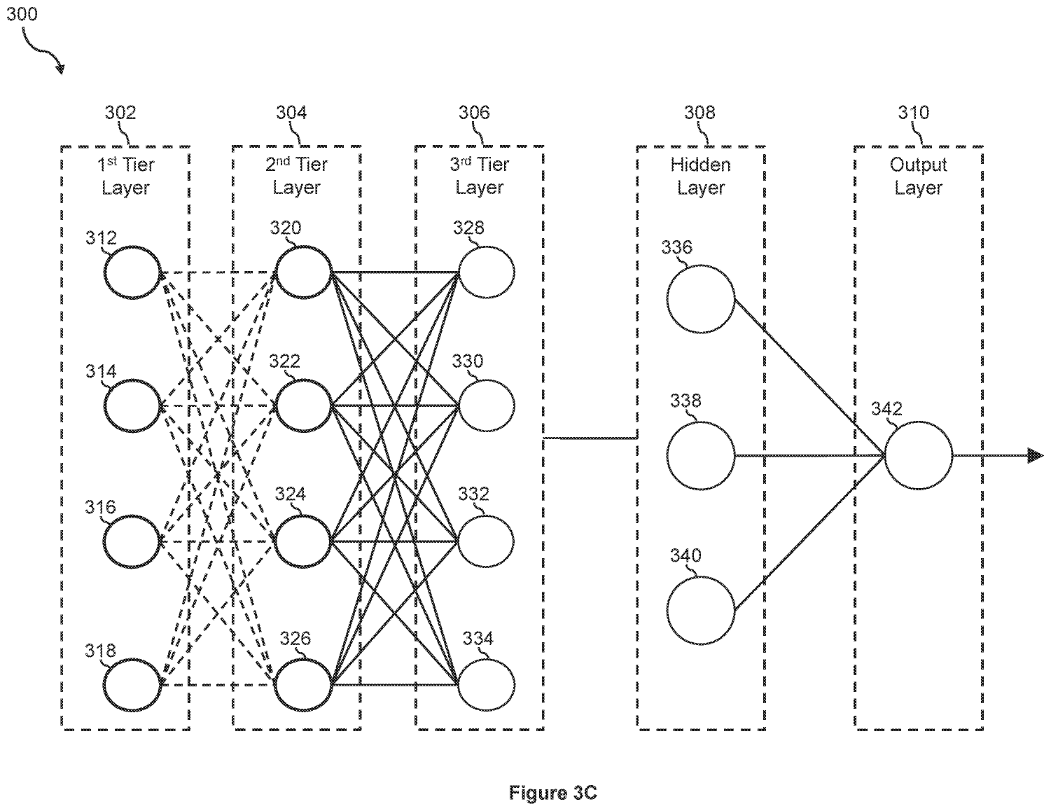

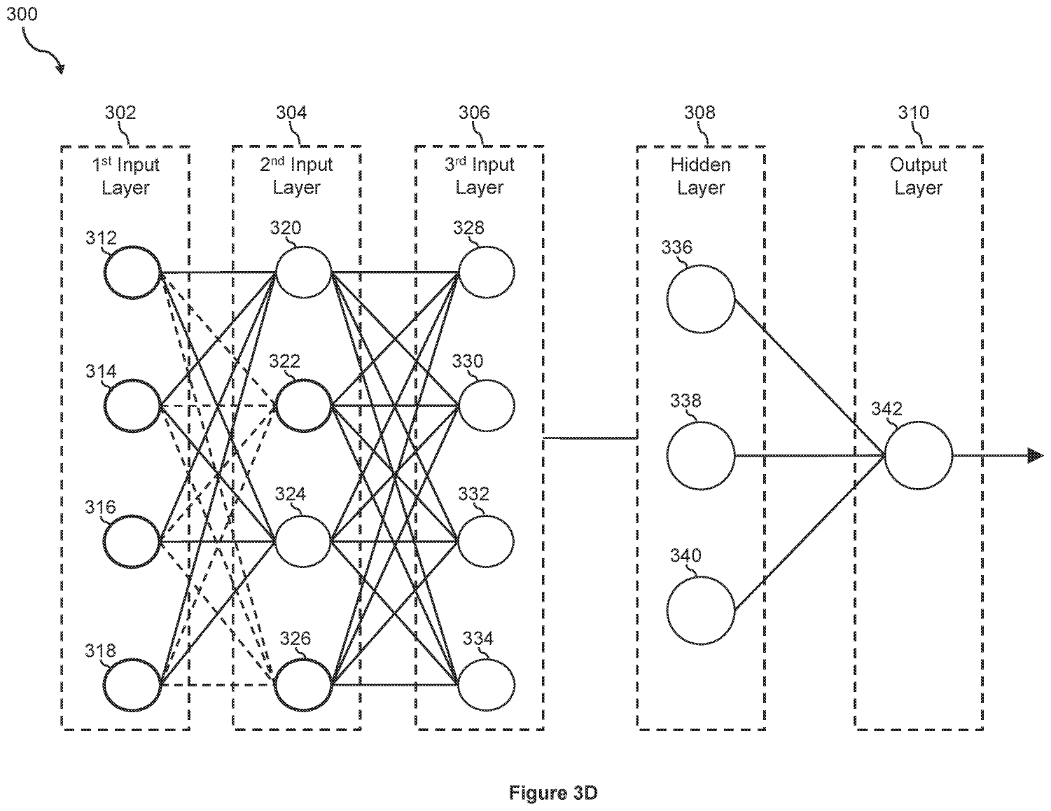

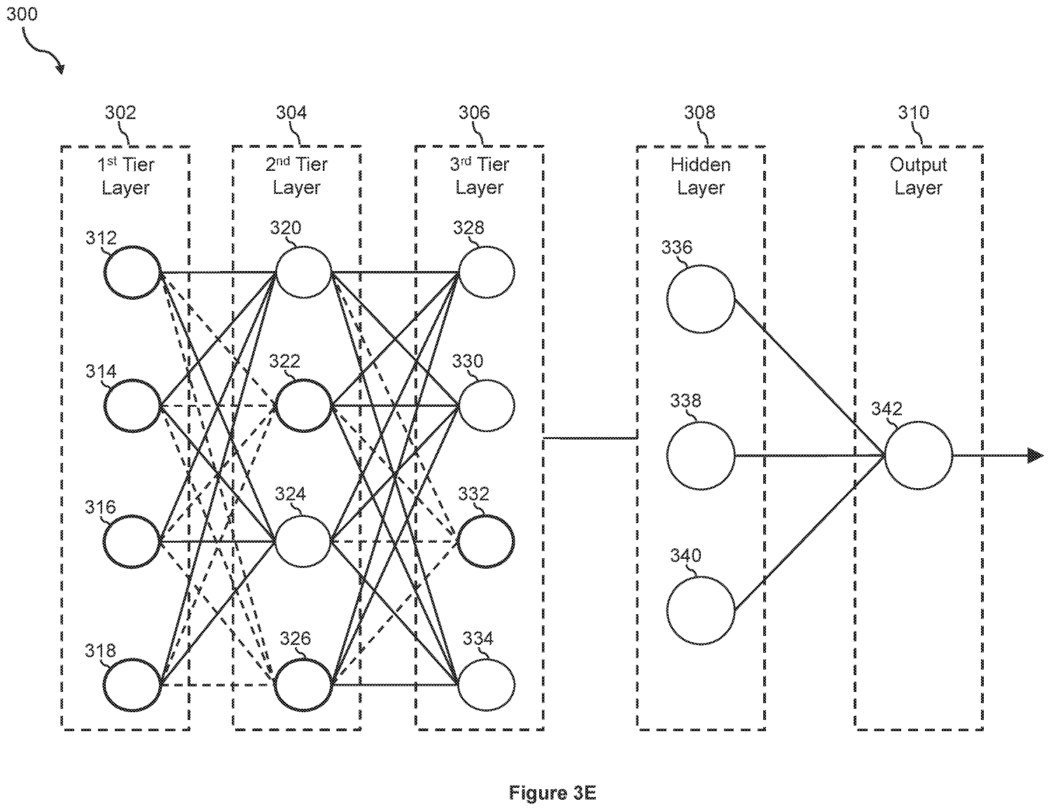

FIG. 3A illustrates an example machine learning model 300 that is implemented using the neural network architecture according to various embodiments of the disclosure. Similar to the artificial neural network 200 of FIG. 2, the machine learning model 300 also includes one or more hidden layers 308 and an output layer 310. Unlike the artificial neural network 200 of FIG. 2, the machine learning model 300 includes multiple input layers. In this example, the machine learning model 300 is illustrated to include three input layers: 302, 304, and 306. However, a machine learning model that is implemented using the neural network architecture as disclosed herein may include any number of input layers (two or more) without departing from the spirit of the disclosure. Each of the input layers may include one or more input nodes. For example, the first input layer 302 includes input nodes 312, 314, 316, and 318. The second input layer 304 includes input nodes 320, 322, 324, and 326. The third input layer 306 includes input nodes 328, 330, 332, and 334.

The inclusion of multiple input layers in the machine learning model 300 enables the machine learning model 300 to connect input nodes in different input layers. In the example shown in FIG. 3A, each of the nodes in each input layer is connected to at least one node in another layer. As shown, each of the nodes 312, 314, 316, and 318 in the first input layer is connected to the nodes 320, 322, 324, and 326 in the second input layer. Each of the nodes 320, 322, 324, and 326 in the second layer is connected to the nodes 312, 314, 316, and 318 in the first input layer, and the nodes 328, 330, 332, and 334 in the third input layer. Each of the nodes 328, 330, 332, and 334 is connected to the nodes 320, 322, 324, and 326 in the second input layer.

These connections among the input nodes, in turn, enables the machine learning model 300 to be trained to infer one input value based one or more other input values. For example, since the node 320 in the second input layer is connected to the nodes 312, 314, 316, and 318 in the first input layer, the machine learning model 300 may be trained to infer an input value corresponding to the node 320 based on input values corresponding to the nodes 312, 314, 316, and 318. Since the node 330 in the third input layer is connected to the nodes 320, 322, 324, and 326 in the second input layer, the machine learning model 300 may be trained to infer an input value corresponding to the node 330 based on input values corresponding to the nodes 320, 322, 324, and 326. As such, the machine learning model 300 may infer the input value corresponding to the node 330 based on other inferred input values in the second input layer 304.

In this example based on the connections among the input nodes, the machine learning model 300 may be trained to infer input values corresponding to the second input layer based on input values corresponding to the first input layer, and to infer input values corresponding to the third input layer based on input values corresponding to the second input layer. However, in some embodiments, the risk analysis module 132 may configure different machine learning models to have different connections among the input nodes using the improved neural network architecture, such that a machine learning model can be configured to infer input values based on different sets of other input values. For example, the risk analysis module 132 may configure another machine learning model such that each input node in the first input layer may be connected to every node in the second input layer and also every node in the third input layer. Under this configuration, the machine learning model may be trained to infer input values corresponding to the third input layer based on both of the input values in the first input layer and the input values in the second input layer.

Each of the input nodes in the first, second, and third input layers may be connected to one or more of the nodes 336, 338, and 340 in the hidden layer 308. For illustration purposes, the machine learning model 300 is shown to include only one hidden layer 308, but a machine learning model that is implemented using the neural network architecture as disclosed herein may include any number of hidden layers without departing from the spirit of the disclosure. When a machine learning model includes multiple hidden layers, each of the input nodes in the different input layers may be connected to one or more nodes in a first hidden layer of the machine learning model.

Each of the nodes 336, 338, and 340 in the hidden layer may obtain input values from the input nodes 312, 314, 316, 318, 320, 322, 324, 326, 328, 330, 332, and 334, and may generate a representation (e.g., an intermediate values) based on the obtained input values using one or more parameters. For example, each of the nodes 336, 338, and 340 may assign different weights to different input nodes 312, 314, 316, 318, 320, 322, 324, 326, 328, 330, 332, and 334, and may generate the representation based on the input values and the different weights assigned to the input nodes.

The output node 342 is configured to obtain the representations generated by the nodes 336, 338, and 340 in the hidden layer 308, and to provide an output value based on the representations. When the machine learning model 300 is configured to predict whether a transaction request is associated with a fraudulent transaction, the output value may indicate a likelihood that the transaction request is associated with a fraudulent transaction.

Due to the neural network architecture that includes multiple input layers, the machine learning model 300 no longer requires all of the input values corresponding to the complete set of input features (input features corresponding to the input nodes 312,314, 316, 318, 320, 322, 324, 326, 328, 330, 332, and 334) to perform a prediction. Specifically, the machine learning model 300 may perform a prediction based on an incomplete set of input values, as long as input values corresponding to the input nodes 312, 314, 316, and 318 in the first input layer are available. Specifically, when input values corresponding to the input nodes 312, 314, 316, and 318 are provided to the machine learning model 300, the machine learning model may use the input values corresponding to the input nodes 312, 314, 316, and 318 to infer input values corresponding to the input nodes 320, 322, 324, and 326 based on the connections between the input nodes in the first input layer 302 and the input nodes in the second input layer 304. The machine learning model may then use the inferred input values corresponding to the input nodes 320, 322, 324, and 326 to further infer the input values corresponding to the 328, 330, 332, and 334 in the third input layer 306 based on the connections between the input nodes in the second input layer 304 and the input nodes in the third input layer 306.

As discussed herein, the risk analysis module 132 may configure the machine learning model 300 differently by including different connections between the input nodes. For example, the risk analysis module 132 may generate another machine learning model in which the input nodes in the first input layer are connected to both the input nodes in the second input layer and the input nodes in the third input layer. In such a configuration, the machine learning model may be trained to use the input values corresponding to the first input layer to infer input values corresponding to the second input layer and the input values corresponding to the third input layer. As such, the architecture is flexible such that the connections among the different input nodes can be configured in many different ways. Though, one important aspect is that while input values corresponding to any other input layer except the first input layer can be inferred in different ways, the input values corresponding to the first input layer cannot be inferred by the machine learning model, and are required to be provided to the machine learning model to perform the inference of other input values and the prediction.

Thus, when designing a machine learning model, the risk analysis module 132 may first determine a set of input features for the machine learning model, and then categorize the set of input features into different tiers. For example, the risk analysis module 132 may determine the multiple tiers of input features based on an estimated timeframe when input data corresponding to the input features would be obtained by the risk analysis system. The risk analysis module 132 of some embodiments may estimate the time frame when input data corresponding to an input feature would be available based on historical retrievals of input data corresponding to the input features. In one example, the risk analysis module 132 may determine three tiers of input features, wherein a first tier includes input features that are available within a first time threshold (e.g., within 0.5 seconds from transmitting a request for the data) most of the time (e.g., at least 95% of the time, at least 99% of the time, etc.), where a second tier includes input features that are available within a second time threshold (e.g., within 1 second from transmitting a request for the data) most of the time (e.g., at least 95% of the time, at least 99% of the time, etc.), and where a third their includes the remaining input features. While three tiers of input features are used to illustrate the inventive concept in this example, any other number of tiers of input features (two or more) can be used without departing from the spirit of this disclosure.

In some embodiments, the risk analysis module 132 may determine the first time threshold and the second time threshold based on the time constraint required for the service application 138 to respond to transaction requests and possibly other factors. For example, if the service application 138 is required to provide a response within a duration from receiving a transaction request, the risk analysis module 132 may determine the first time threshold as a first portion of the duration (e.g., half of the duration, a quarter of the duration, etc.), and may determine the second time threshold as a second portion of the duration that is larger than the first duration (e.g., three quarters of the duration, etc.). In some embodiments, the second threshold may be determined as a percentage or fixed time period deviation from the first time threshold. In some embodiments, the risk analysis module 132 may also consider other factors such as holidays, urgency of the request, etc. to determine the first time threshold and the second time threshold. The risk analysis module 132 may then assign the different input features to the different input layers of the machine learning model 300 based on their tiers. For example, the risk analysis module 132 may assign the first tier of input features to the input nodes in the first input layer 302 of the machine learning model 300, may assign the second tier of input features to the input nodes in the second input layer of the machine learning model 300, and may assign the third tier of input features to the input nodes in the third input layer of the machine learning model 300.

Upon receiving a transaction request, the risk analysis module 132 may attempt to retrieve the input values corresponding to the complete set of input features. For example, the risk analysis module 132 may transmit data requests to different devices (e.g., a user device that initiated the transaction request, internal servers and databases such as the account database, external servers, etc.). The risk analysis module 132 may wait (e.g., idle) for a predetermined period of time to allow input values corresponding to the various input features to be obtained from the different devices. The predetermined period of time may be determined to be longer than the first time threshold associated with the first tier of input features. The risk analysis module 132 may use a machine learning model (e.g., the machine learning model 300) to perform a prediction based on input values available to the risk analysis module 132 at the expiration of the predetermined period of time.

Since it is highly likely that the risk analysis module 132 can obtain at least the input values corresponding to the first tier of input features at the expiration of the predetermined time period, the risk analysis module 132 may provide the available input values to the machine learning model 300 for performing the prediction.

FIG. 3B illustrates the machine learning model 300 for performing a prediction when only input values corresponding to the first input layer (e.g., first tier of input features) are available. When only the input values corresponding to the first input layer are available, the risk analysis module 132 may retain all of the connections among the input nodes within the machine learning model 300 for performing the prediction. The risk analysis module 132 may then provide the input values to the machine learning model 300. Specifically, the input values are provided to the corresponding input nodes 312, 314, 316, and 318 in the first input layer 302 of the machine learning model 300. Since the input values corresponding to the input nodes in the second input layer 304 and the third input layer 306 are missing, upon obtaining the input values, the machine learning model 300 may infer the missing input values based on the connections between the input nodes 312, 314, 316, and 318 in the first input layer 302 and the input nodes in the second layer 304 and the third layer 306. The machine learning model 300 may then provide the available input values and the inferred input values to the hidden layer 308, where various representations may be generated based on the input values. The output node 342 of the output layer 310 may generate an output value based on the representations generated by the hidden layer 308.

It is possible that at the time the risk analysis module 132 uses the machine learning model 300 to perform a prediction (e.g., at the expiration of the predetermined period of time), one or more input values corresponding to one or more input nodes in the second input layer 304 and/or the third layer 306 are also available to the risk analysis module 132, in addition to the input values corresponding to the first input layer 302. The risk analysis module 132 may choose to ignore the other input values, as the machine learning model 300 is capable of performing the prediction based solely on the input values corresponding to the first input layer 302. However, the availability of actual input values associated with the transaction request can improve the accuracy performance of the machine learning model 300. Thus, in some embodiments, the risk analysis module 132 may use all available input values to perform the prediction.

As certain input values corresponding to one or more input nodes in the second input layer 304 and/or the third input layer 306 are available and do not need to be inferred by the machine learning model 300, the risk analysis module 132 may modify the machine learning model 300 for this instance of prediction. In some embodiments, the risk analysis module 132 may identify the input node(s) in the second input layer 304 and/or the third input layer 306 that corresponds to the input values that are available to the risk analysis module 132. The risk analysis module 132 may remove (or mask) any backward connections connected to the identified input nodes. Backward connections are connections that connect the identified input nodes to another input node in a preceding input layer. The removal of the backward connections ensures that the machine learning model 300 will not infer the input values that are available to the risk analysis module 132.

FIG. 3C illustrates the machine learning model 300 after being modified by the risk analysis module 132 based on the availability of input values corresponding to the first tier of input features and the second tier of input features. In this example, the input values corresponding to all of the first input layer 302 and the second input layer 304 are available to the risk analysis module 132. As such, the risk analysis module 132 modifies the machine learning model 300 by removing backward connections that are connected to the input nodes 320, 322, 324, and 326 in the second input layer 304 (as shown by the dotted lines representing the removed backward connections). Those backward connections include the connections between the nodes 320, 322, 324, and 326 in the second input layer 304 and the nodes 312, 314, 316, and 318 in the first input layer. By removing those backward connections, it forces the machine learning model 300 to use the actual input values corresponding to the input nodes 320, 322, 324, and 326 that are available to the risk analysis module 132 instead of inferring those input values from other input values corresponding to the nodes 312, 314, 316, and 318.

FIG. 3C illustrates that the risk analysis module 132 may modify the machine learning model 300 based on the availability of the input values. In the example shown in FIG. 3C, the input values of the entire second tier of input features (corresponding to the entire set of input nodes in the second input layer 304) are available to the risk analysis module 132 when the risk analysis module 132 performs the prediction. However, it is not always possible that the input values corresponding to the entire tier of input features is available on time.

FIG. 3D illustrates a modification to the machine learning model 300 based on the availability of input values corresponding to some, but not all, of the second tier of input features. In this example, in addition to the input values corresponding to the first input layer 302, input values corresponding to the nodes 322 and 326 of the second input layer 304, but not any input values corresponding to the other input nodes 320 and 324 of the second input layer 304 and input nodes of the third input layer 306, are available to the risk analysis module 132 at the time the risk analysis module 132 performs the prediction. Based on the availability of the input values corresponding to the nodes 322 and 326, the risk analysis module 132 may modify the machine learning model 300 by removing the backward connections that are connected to the input nodes 322 and 326 (as shown by the dotted lines representing the removed backward connections). Those backward connections include the connections between the nodes 322 and 326 in the second input layer 304 and the nodes 312, 314, 316, and 318 in the first input layer. By removing those backward connections, it forces the machine learning model 300 to use the actual input values corresponding to the input nodes 322 and 326 that are available to the risk analysis module 132 instead of inferring those input values from other input values corresponding to the nodes 312, 314, 316, and 318.

FIG. 3E illustrates another modification to the machine learning model 300 based on the availability of input values corresponding to some of the second tier of input features and some of the third tier of input features. In this example, in addition to the input values corresponding to the first input layer 302, input values corresponding to the input nodes 322 and 326 of the second input layer 304, and the input node 332 of the third input layer 306, are available to the risk analysis module 132 at the time the risk analysis module 132 performs the prediction. Based on the availability of the input values corresponding to the nodes 322, 326, and 332, the risk analysis module 132 may modify the machine learning model 300 by removing the backward connections that are connected to the input nodes 322, 326, and 332 (as shown by the dotted lines representing the removed backward connections). Those backward connections include the connections between the nodes 322 and 326 in the second input layer 304 and the nodes 312, 314, 316, and 318 in the first input layer, and the connections between the node 332 in the third input layer 306 and the nodes 320, 322, 324, and 326 in the second input layer 304. By removing those backward connections, it forces the machine learning model 300 to use the actual input values corresponding to the input nodes 322, 326, and 322 that are available to the risk analysis module 132 instead of inferring those input values from other input values corresponding to the nodes 312, 314, 316, 318, 320, and 324.

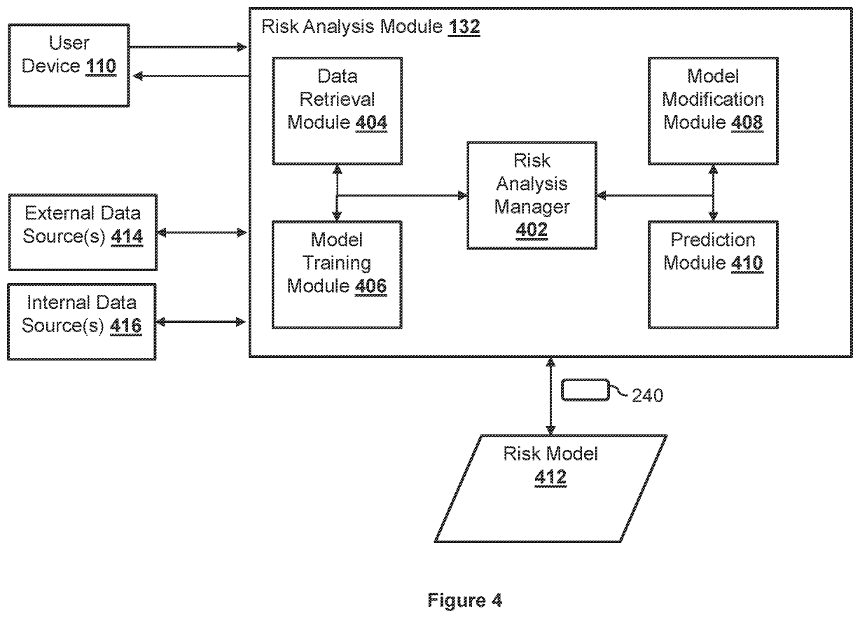

FIG. 4 illustrates a block diagram of the risk analysis module 132 according to an embodiment of the disclosure. The risk analysis module 132 includes a risk analysis manager 402, a data retrieval module 404, a model training module 406, a model modification module 408, and a prediction module 410. The risk analysis manager 402 may receive prediction requests from other software modules and/or other devices. For example, the service provider server 130, through the interface server 132, may receive a transaction request from the user device 110. The transaction request may be a request to log in to a user account with the service provider server 130, a request to access data hosted by the service provider server 130, a request to perform a transaction (e.g., a payment transaction), or any other types of transaction requests. The transaction request may be routed to the service application 138 for processing. However, the service application 138 may be configured to process the transaction request based on a prediction output provided by the risk analysis module 132. Thus, the service application 138 may transmit a prediction request to the risk analysis module 132 based on the transaction request.

Upon receiving the prediction request, the risk analysis module 132 may use a machine learning model (e.g., risk model 412) to perform a prediction (e.g., provide an output value that indicates a prediction, such as a prediction of whether the transaction request is associated with a fraudulent transaction). As such, the risk analysis module 132 may have generated the risk model 412 for performing predictions for the service application 138. In some embodiments, the risk model 412 may be generated as an artificial neural network based on the neural network architecture as disclosed herein, similar to the machine learning model 300 illustrated in FIGS. 3A-3E. The risk analysis manager 402 may first determine a set of input features that is relevant in performing the prediction. For example, when the risk model 412 is configured to predict whether a transaction request is a legitimate transaction request or a fraudulent transaction request, the set of input features may include an input feature associated with an Internet Protocol (IP) address of a device that initiates the transaction request, another input feature associated with a time when the transaction request is received, another input feature associated with an average transaction amount previously conducted by a user who initiated the transaction request, another input feature associated with a physical location of the device that initiates the transaction request, another input feature associated with a credit of the user who initiated the transaction request, and possibly other input features.

The risk analysis manager 402 may then categorize the set of input features into multiple tiers (e.g., 2 tiers, 3 tiers, 5 tiers, etc.) based on how quickly values corresponding to those input features can be obtained. In one example, the risk analysis manager 402 may assign input features that can be obtained within a first time threshold most of the time (e.g., 90%, 95%, 98%, etc.) to a first tier, may assign input features that can be obtained within a second time threshold longer than the first time threshold most of the time (e.g., 90%, 95%, 98%, etc.) to a second tier, and may assign the remaining input features to a third tier. The risk analysis manager 402 may then generate the risk model 412 based on the input features and their assigned tiers. For example, based on the three tiers in which the input features are categorized, the risk analysis manager 402 may configure the risk model 412 to include three input layers. The risk analysis manager 402 may also create, for each input layer, input nodes for input features in the corresponding tier. For example, the risk analysis manager 402 may create, for a first input layer of the risk model 412, input nodes corresponding to the input features that are assigned to the first tier. The risk analysis manager 402 may also create, for a second input layer of the risk model 412, input nodes corresponding to the input features that are assigned to the second tier. The risk analysis manager 402 may also create, for a third input layer of the risk model 412, input nodes corresponding to the input features that are assigned to the third tier.

The risk analysis manager 402 may then create connections among the input nodes in different input tiers. In some embodiments, the risk analysis manager 402 may connect each input node in an input layer to one or more input nodes in a succeeding layer. For example, the risk analysis manager 402 may connect a first input node in the first input layer to all of the input nodes in the second input layer, and connect a second input node in the second input layer to all of the input nodes in the third input layer, similar to how the machine learning model 300 is configured. In some embodiments, the risk analysis manager 402 may connect each input node in an input layer to one or more input nodes in every succeeding layer. For example, the risk analysis manager 402 may connect the first input node in the first input layer to all of the input nodes in the second input layer and all of the input nodes in the third input layer. The risk analysis manager 402 may also connect the second input node in the second input layer to all of the input nodes in the third input layer. This way, each input value in the second input layer and the third input layer may be inferred based on input values from all of the preceding input layers. The risk model 412 is not limited to any particular manner in connecting the input nodes among the different input layers, and configure the connections the way it sees fit for the model.

The risk manager 402 may then generate the nodes in one or more hidden layers and the output layer, in a manner similar to a conventional artificial neural network. In some embodiments, the risk manager 402 may connect each input node in every input layer of the risk model 412 to all of the nodes in the first hidden layer of the risk model 412. After generating and configuring the risk model 412, the risk manager 402 may use the model training module 406 to train the risk model 412. The connections among the input nodes in different input layers enable the risk model 412 to be trained to infer one input value from one or more other input values. For example, when a first input node representing a first input feature is connected to a second input node representing a second input feature, the risk model 412 may be trained to infer an input value corresponding to the second input feature based on another input value corresponding to the first input feature. Since the first input layer includes input nodes that represents the first tier of input features (e.g., features that would be obtained the fastest), the input values corresponding to the first tier of input features may be used by the risk model 412 to infer (e.g., predict) input values corresponding to input features in the succeeding tiers (e.g., the second tier and/or the third tier). With sufficient training data, the risk model 412 may learn to infer input features in the second tier based on the first tier of input features, and learn to infer input features in the third tier based on the first tier of input features and/or the second tier of input features accurately. Based on the connections between the input nodes and the nodes in the hidden layer(s) of the risk model 412, the risk model 412 may be trained to perform a prediction based on available input values that are provided to the risk model 412 (e.g., input values that correspond to the first input layer) and inferred input values that were missing (not provided to the risk model 412) but are inferred by the risk model 412 based on the other input values provided to the risk model 412. This way, even with an incomplete set of input values, the risk model 412 can still provide accurate predictions because the risk model 412 is trained to infer the missing input values to provide the prediction output.

During the training phase, the model training module 406 may use different training data sets to train the machine learning model. The training data sets may include historical data, such as transaction data associated previously conducted transactions by various users of the service provider server 130. In some embodiments, the model training module 406 may obtain the transaction data from the accounts database 136 as training data sets. Thus, each training set may include transaction data associated with a previously conducted transaction. Since the transaction was conducted in the past, a complete set of input values corresponding to the entire set of input features is available to the model training module 406. In some embodiments, the model training module 406 may use the complete sets of data values to train the risk model 412 to predict outcomes based on the complete sets of data values. When the complete set of data values is provided to the risk model 412, the model training module 406 may modify the risk model 412 by removing the connections among the input nodes, since no inference of input values is needed in this training scenario.

In some embodiments, in addition to training the risk model 412 using complete sets of data values, the model training module 406 may select different subsets of the training data sets to train the risk model 412. In other words, the model training module 406 may also train the risk model 412 using incomplete sets of data values. For example, after obtaining a training data set corresponding to a complete set of input features associated with the risk model 412, the model training module 406 may select one or more different subsets of the training data set for training the risk model 412. In a first training scenario, the model training module 406 may eliminate the input values corresponding to the third input layer from the training data set. In this first training scenario, the model training module 406 may modify the risk model 416 by removing the connections between the input nodes in the first input layer and the input nodes in the second input layers (since there is no need to infer input values corresponding to the second input layer).

In a second training scenario, the model training module 406 may eliminate all of the input values corresponding to the second input layer and the third input layer. Thus, the model training module 406 provides to the risk model only the input values corresponding to the first input layer. In this second training scenario, the model training module 406 may not modify the risk model 412 as it is necessary to infer input values of both the second tier and third tier of input features. In some embodiments, the model training module 406 may continue to select different subsets of the training data set in different training scenarios to train the risk model 412. For example, the model training module 406 may select different input values corresponding to the second input layer and the third input layer (e.g., selecting two out of five input values corresponding to the second input layer and selecting one out of five input values corresponding to the third input layer). The model training module 406 may combine the selected input values corresponding to the second and third input layers with the input values corresponding to the first input layer to train the risk model 412. Based on which input values from the second input layer and/or the third input layer are selected, the model training module 406 may modify the risk model 412 before the training (by eliminating unneeded connections).

The model training module 406 may continuously select different subsets of each training data set, modify the risk model 412 based on the selected input values, and train the risk model 412. Based on training the risk model 412 using a combination of complete sets of input values and different incomplete sets of input values, the risk model 412 may be trained to accurately predict an outcome based on different subsets of available input values (different missing values).

Once the risk model 412 is trained, the risk manager 402 may use the risk model 412 to perform predictions for various transaction requests. Upon receiving a request for performing a prediction associated with a transaction request, the risk analysis manager 402 may use the data retrieval module 404 to retrieve transaction data associated with the transaction request. As discussed herein, the transaction data may be used as input data values to be provided to the risk model 412 for performing a prediction. The transaction data may include data that is obtainable from different sources, such as the user device 110 that initiated the transaction request, one or more internal data sources 414 such as the accounts database 136, and one or more external data sources 416 such as a credit bureau server. In some embodiments, the data retrieval module 404 may transmit data requests to the data sources in order to obtain the transaction data associated with the transaction request. Due to a various of factors such as network delay, processor bandwidth, processing required for preparing the transaction data, and other factors, the transaction data may be obtained by the data retrieval module 404 at different times.

However, the risk analysis module 132 may be required to provide a prediction output within a particular time constraint by the service application 138. As such, the risk analysis manager 402 may not wait until all of the transaction data is available before performing the prediction. In some embodiments, the risk analysis manager 402 may determine a wait time period for obtaining the transaction data. When the risk analysis manager 402 determines that the wait time period has expired, the risk analysis manager 402 may provide whatever transaction values that have been obtained by the data retrieval module 404 as input values to the risk model 412 for performing a prediction for the transaction request. In some embodiments, the risk analysis 408 may use the model modification module 408 to modify the risk model 412 before performing the prediction based on the input features corresponding to the data values that are available. For example, the model modification module 408 may be configured to remove backward connections that are connected to input nodes in the second input layer and/or the third input layer of the risk model 412 corresponding to the input values that are available to the risk analysis manager 402. The removal of these backward connections forces the risk model 412 to use the actual input values corresponding to the second input layer and/or the third input layer that are available and provided to the risk model 412 instead of inferring the input values from other input values corresponding to the first input layer.

The prediction module 410 may obtain the prediction value from the output node of the risk model 412. In some embodiments, the prediction value may indicate a likelihood of whether the transaction request is associated with a fraudulent transaction. The prediction module 410 may provide the prediction value to the service application 138 such that the service application 138 may process the transaction request based on the prediction value. For example, the service application 138 may authorize the transaction request when the prediction value indicates that the transaction request is likely not associated with a fraudulent transaction (e.g., the prediction value is below a threshold), and may deny the transaction request when the prediction value indicates that the transaction request is likely associated with a fraudulent transaction (e.g., the prediction value is above the threshold).

In some embodiments, before providing the prediction value to the service application, the prediction module 410 may first verify an accuracy of input data inferences of the risk model 412 for this transaction request. For example, in addition to using the risk model 412 to perform the prediction based on all input values that are available to the risk analysis module 132, the prediction module 410 may also use the risk model 412 to perform a second prediction, using only the input values corresponding to the first input layer. By providing only the input values corresponding to the first input layer to the risk model 412, the prediction module 410 forces the risk model 412 to infer all of the input values corresponding to the second input layer and the third input layer, and use the inferred input values from the second input layer and the third input layer to provide the prediction value. The prediction value generated during the second prediction may be different than the prediction value generated during the initial prediction, in which some of the input values in the second input layer and/or the third input layer are actual input values, rather than inferred input values. If the inferences of the input values are accurate, the prediction value generated during the second prediction should be within a threshold deviation (e.g., within 5%, within 10%) of the prediction value generated during the initial prediction.

In some embodiments, the prediction module 410 may provide the prediction value generated during the initial prediction to the service application 138 when the difference between the prediction value generated during the second prediction and the prediction value generated during the initial prediction is within the threshold deviation. In some embodiments, when the difference is larger than the threshold deviation, the prediction module 410 may still provide the prediction value to the service application 138, along with a warning message indicating that the prediction value may not be accurate. In some embodiments, when the difference is larger than the threshold deviation, the prediction module 410 may wait for another period such that additional input values may become available, and may use the risk model 412 to perform the prediction again based on the newly available input values. The prediction module 410 may provide the new prediction value to the service application 138.

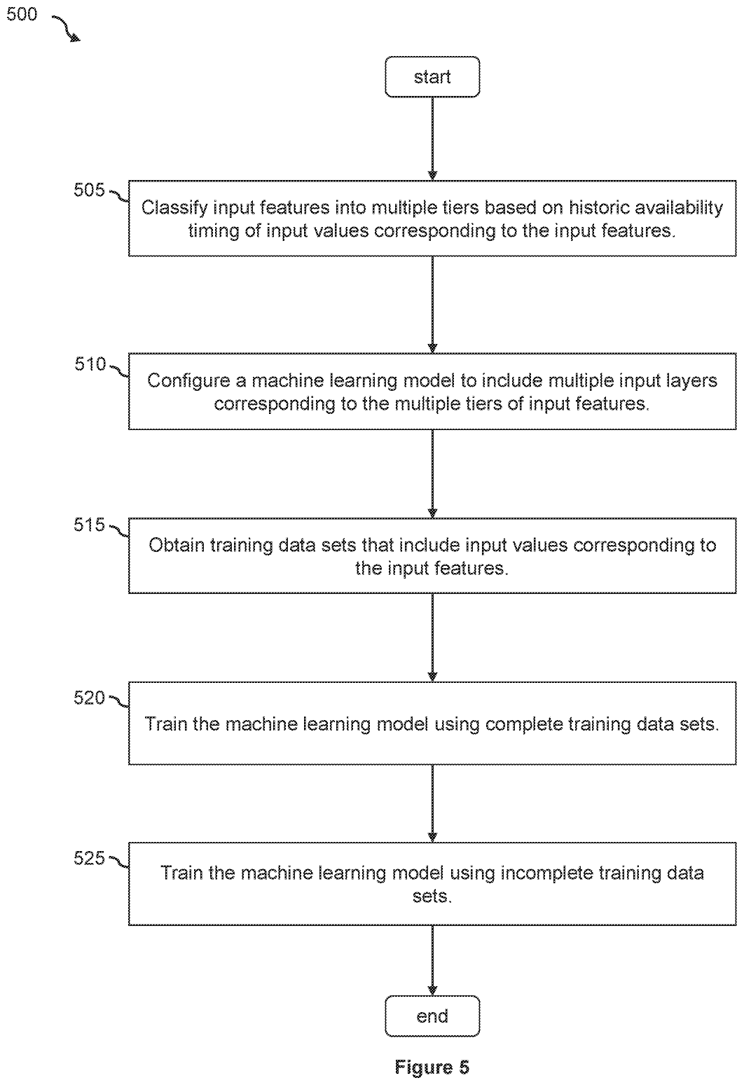

FIG. 5 illustrates a process 500 for generating a machine learning model based on the neural network architecture according to various embodiments of the disclosure. In some embodiments, the process 500 may be performed by the risk analysis module 132. The process 500 begins by classifying (at step 505) input features into multiple tiers based on historic availability timing of input values corresponding to the input features. For example, the risk analysis manager 402 may analyze timing of obtaining input values corresponding to the different input features associated with the risk model 412 during processing of transaction requests in the past. The risk analysis manager 402 may classify input features that are most likely obtained within a first time threshold in a first tier and classify input features that are most likely obtained within a second time threshold in a second tier, and so forth.

The process 500 then configures (at step 510) a machine learning model to include multiple input layers corresponding to the multiple tiers of input features. For example, the risk analysis manager 402 may generate a number of input layers for the risk model 412 based on the number of tiers into which the input features are classified. For example, if the input features are classified into three tiers, the risk analysis manager 402 may generate three input layers for the risk model 412. The risk analysis manager 402 may also generate input nodes corresponding to the input features in the input layers.

After configuring the machine learning model, the process 500 obtains (at step 515) training data sets that include input values corresponding to the input features. For example, the risk analysis manager 402 may retrieve, from the accounts database 136, transaction data associated with transactions conducted by various user accounts in the past. The process 500 then trains (at step 520) the machine learning model using complete training data sets. For example, the model training module 406 may provide the training data sets as input values to the risk model 412 for training the risk model 412. In some embodiments, since the training data sets include complete sets of input values for the risk model 412 (e.g., all of the input values corresponding to the input nodes in the different input layers), the risk model 412 is not required to infer any input values. Thus, the model training module 406 may modify the risk model 412 by removing the connections among the input nodes before training the risk model 412 using the complete training data sets.

The process 500 then trains (at step 525) the machine learning model using incomplete training data sets. For example, the model training module 406 may select, for each training data set, different subsets of the input values for training the risk model 412. The model training module 406 may always select input values corresponding to the first input layer, but varying different subsets of input values corresponding to the second input layer and the third input layer. The model training module 406 may also dynamically modify the risk model 412 by removing certain connections among the input nodes based on which input values are selected to be provided to the risk model 412. By training the risk model 412 using complete and incomplete training data sets, the risk model 412 is trained to predict the output value based on complete sets of input values, to infer missing input values based on other available input values, and to predict the output value based on a combination of available input values and missing input values.

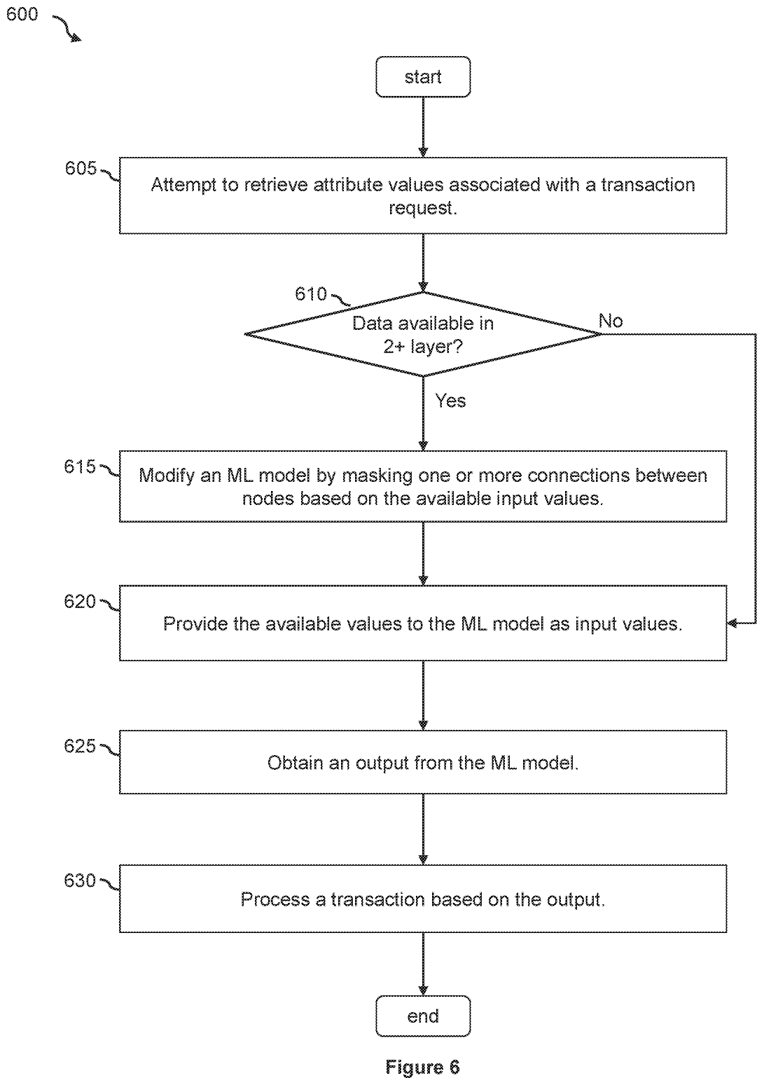

FIG. 6 illustrates a process 600 for using a machine learning model to perform predictions according to various embodiments of the disclosure. In some embodiments, the process 600 may be performed by the risk analysis module 132. The process 600 begins by attempting (at step 605) to retrieve attribute values associated with a transaction request. For example, the service provider server 130 may receive a transaction request from a device (e.g., the user device 110). To process the transaction request, the service application 138 may need to use the risk analysis module 132 to determine a risk of the transaction request being associated with a fraudulent transaction. Thus, the risk analysis manager 402 may use the data retrieval module 404 to retrieve transaction data associated with the transaction request. However, as discussed herein, different transaction data may be available to the risk analysis module 132 at different time, and the risk analysis module 132 may not be able to wait for all of the transaction data to become available before performing the prediction due to a time constraint. As such, the prediction module 410 may be configured to use the risk model 410 to perform the prediction when a time period after receiving the transaction request has expired. The prediction module 410 may use whatever input values that are available to the risk analysis module 132 to perform the prediction.

At step 610, the process 600 determines whether any input values corresponding to the second input layer or above are available. If any input values in the second input layer or above are available, the process 600 modifies (at step 615) the machine learning model by masking one or more connections between the nodes based on the available input values, and then provide (at step 620) the available values to the machine learning model as input values. On the other hand, if none of the input values corresponding to the second input layer or above is available, the process 600 proceeds directly to step 620 to provide the available values to the machine learning model as input values, without modifying the machine learning model.

The process 600 then obtains (at step 625) an output from the machine learning model. For example, the prediction module 410 may obtain a prediction output from the risk model 412, which indicates a likelihood that the transaction request is associated with a fraudulent transaction. The process 600 processes (at step 630) a transaction based on the output. For example, the prediction module 410 may provide the output from the risk model 412 to the service application 138. The service application 138 may process the transaction request based on the output.

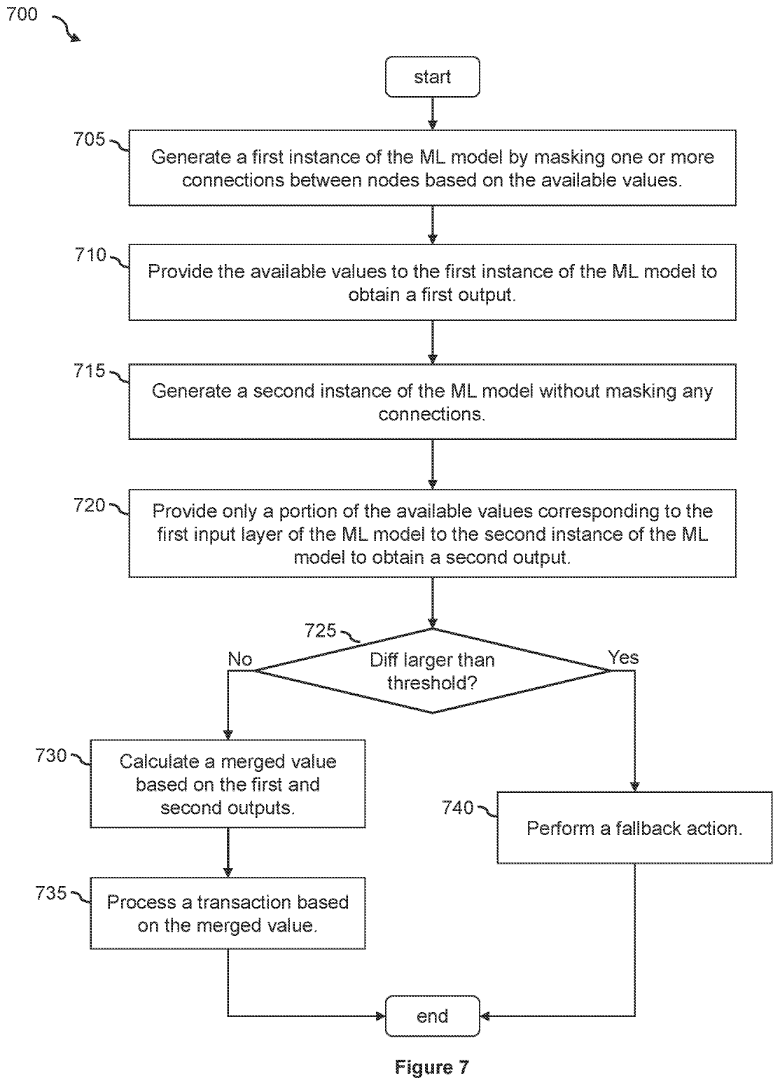

FIG. 7 illustrates a process 700 for verifying a machine learning model's accuracy of input data inference according to various embodiments of the disclosure. In some embodiments, the process 700 may be performed by the risk analysis module 132. The process 700 begins by generating (at step 705) a first instance of the machine learning model by masking one or more connections between nodes based on the available values and providing (at step 710) the available values to the first instance of the machine learning model to obtain a first output. Similar to the step 615 in FIG. 6, the model modification module 408 may modify the risk model 412 by removing one or more backward connections that are connected to input nodes corresponding to the available input values. The prediction module 410 may provide all of the available input values retrieved from the data retrieval module 404 to the modified risk model 412 to perform a first prediction, and may obtain a first output value from the risk model 412.

The process 700 then generates (at step 715) a second instance of the machine learning model without masking any connections and provides (at step 720) the only a portion of the available values corresponding to the first input layer of the machine learning model to the second instance of the machine learning model to obtain a second output. For example, the prediction module 410 may use the risk model 412 to perform a second prediction. Unlike the first prediction, the prediction module 410 may provide only input values that correspond to the first input layer of the risk model 412 to the risk model 412 to perform the second prediction. The prediction module 410 may obtain a second output value from the risk model 412.

The process 700 determines (at step 725) if the difference between the first output and the second output is larger than a threshold. If the difference is not larger than the threshold, the process 700 calculates (at step 730) a merged value based on the first and second outputs and processes (at step 735) a transaction based on the merged value. On the other hand, if the difference is larger than the threshold, the process 700 performs (at step 740) a fallback action. For example, the prediction module 410 determines whether a difference between the first output value and the second output value is larger than a threshold. A small or no difference between the first output value and the second output value may indicate that the risk model 412 is capable of accurately inferring input values based on other input values. When that is the case, the prediction module 410 may simply provide the first output value (that is generated based on providing all of the available input values to the risk model 412) to the service application 138 for processing the transaction request. In some embodiments, in order to compensate any potential data inference errors, the prediction module 410 may calculate a merged value based on the first output value and the second output value (e.g., an average, etc.), and provide the merged value to the service application 138 for processing the transaction request.

On the other hand, a large difference between the first output value and the second output value may indicate that the risk model 412 is incapable of accurately inferring input values based on other input values. As such, the prediction module 410 may perform a fallback action. In some embodiments, the prediction module 410 may still provide the first output value to the service application 138, but also include an indication that the value may not be an accurate prediction. In some embodiments, the risk analysis manager 402 may wait for another period of time, such that additional input values may become available to the risk analysis module 132. The prediction module 410 may then use the input values that were used to perform the first prediction, along with the newly available input values, to perform a third prediction. The prediction module 410 may obtain a third output value from the risk model 412 based on the newly available input values, and may provide the third output value to the service application 138 for processing the transaction request.

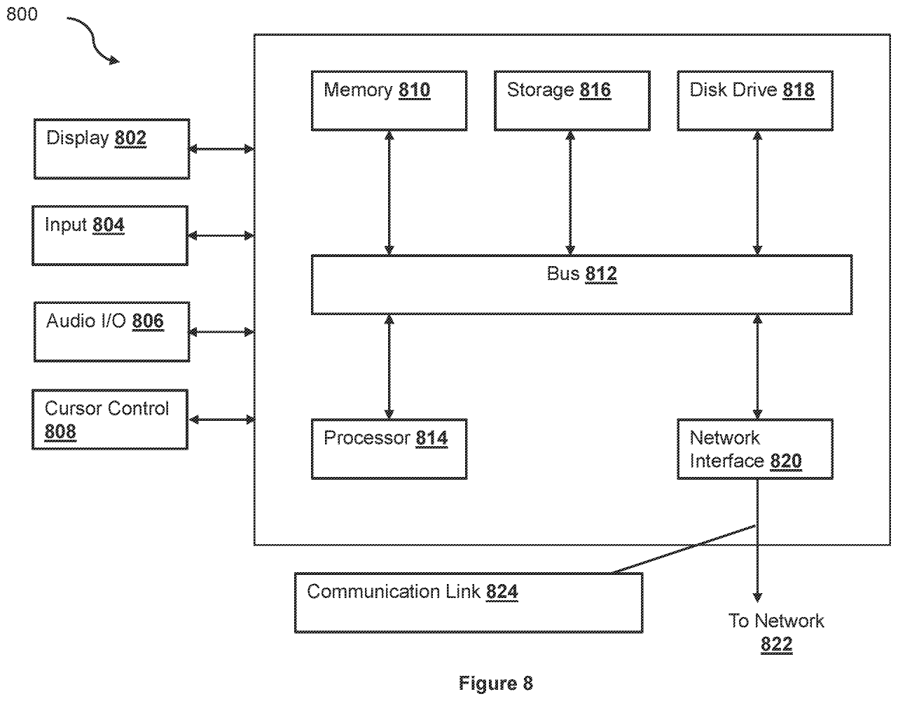

FIG. 8 is a block diagram of a computer system 800 suitable for implementing one or more embodiments of the present disclosure, including the service provider server 130, the merchant server 120, the user device 110, and the third-party servers 150 and 160. In various implementations, the user device 110 may include a mobile cellular phone, personal computer

(PC), laptop, wearable computing device, etc. adapted for wireless communication, and each of the service provider server 130, the merchant server 120, and the third-party servers 150 and 160 may include a network computing device, such as a server. Thus, it should be appreciated that the devices 110, 120, 130, 150, and 160 may be implemented as the computer system 800 in a manner as follows.

The computer system 800 includes a bus 812 or other communication mechanism for communicating information data, signals, and information between various components of the computer system 800. The components include an input/output (I/O) component 804 that processes a user (i.e., sender, recipient, service provider) action, such as selecting keys from a keypad/keyboard, selecting one or more buttons or links, etc., and sends a corresponding signal to the bus 812. The I/O component 804 may also include an output component, such as a display 802 and a cursor control 808 (such as a keyboard, keypad, mouse, etc.). The display 802 may be configured to present a login page for logging into a user account or a checkout page for purchasing an item from a merchant. An optional audio input/output component 806 may also be included to allow a user to use voice for inputting information by converting audio signals. The audio I/O component 806 may allow the user to hear audio. A transceiver or network interface 820 transmits and receives signals between the computer system 800 and other devices, such as another user device, a merchant server, or a service provider server via network 822. In one embodiment, the transmission is wireless, although other transmission mediums and methods may also be suitable. A processor 814, which can be a micro-controller, digital signal processor (DSP), or other processing component, processes these various signals, such as for display on the computer system 800 or transmission to other devices via a communication link 824. The processor 814 may also control transmission of information, such as cookies or IP addresses, to other devices.

The components of the computer system 800 also include a system memory component 810 (e.g., RAM), a static storage component 816 (e.g., ROM), and/or a disk drive 818 (e.g., a solid state drive, a hard drive). The computer system 800 performs specific operations by the processor 814 and other components by executing one or more sequences of instructions contained in the system memory component 810. For example, the processor 814 can perform the risk analysis functionalities described herein according to the processes 500, 600, and 700.

Logic may be encoded in a computer readable medium, which may refer to any medium that participates in providing instructions to the processor 814 for execution. Such a medium may take many forms, including but not limited to, non-volatile media, volatile media, and transmission media. In various implementations, non-volatile media includes optical or magnetic disks, volatile media includes dynamic memory, such as the system memory component 810, and transmission media includes coaxial cables, copper wire, and fiber optics, including wires that comprise the bus 812. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 800. In various other embodiments of the present disclosure, a plurality of computer systems 800 coupled by the communication link 824 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub- components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
retrieving attribute values corresponding to a set of attributes and associated with a transaction;
determining, at a first point in time subsequent to the retrieving, a first subset of the attribute values, but not a second subset of the attribute values, is available;
modifying a first instance of a machine learning model based on an availability of the first subset of the attribute values;
providing the first subset of the attribute values as input values to the modified first instance of the machine learning model, wherein the modified first instance of the machine learning model is configured to impute the second subset of the attribute values based on the first subset of the attribute values and to produce a first output based on the first subset of the attribute values and the imputed second subset of the attribute values; and
performing, for the transaction, an action based on the first output.

2. The system of claim 1, wherein the machine learning model comprises an artificial neural network that includes a plurality of layers of nodes, wherein the plurality of layers of nodes comprises a plurality of input layers that includes a plurality of input nodes and a plurality of connections connecting the plurality of input nodes, wherein the modifying the first instance of the machine learning model comprises:
masking at least one of the plurality of connections in the first instance of the machine learning model.

3. The system of claim 2, wherein the masking comprises:
identifying a first input node in a first input layer of the artificial neural network that corresponds to a first attribute value in the first subset of the attribute values; and
masking a backward connection that is connected to the first input node.

4. The system of claim 2, wherein the modifying the first instance of the machine learning model further comprises:
identifying a second input node in a second input layer of the artificial neural network that corresponds to a second attribute value in the first subset of the attribute values; and
masking a second backward connection that is connected to the second input node.

5. The system of claim 1, wherein the machine learning model comprises an artificial neural network that includes a plurality of layers of nodes, wherein the plurality of layers of nodes comprises at least a first input layer and a second input layer, and wherein the operations further comprise:
providing a first portion of the first subset of the attribute values that corresponds to input nodes in the first input layer of the artificial neural network as input values to a second instance of the machine learning model, wherein the second instance of the machine learning model is configured to impute a second portion of the first subset of the attribute values and the second subset of the attribute values based on the first portion of the first subset of the attribute values, and to produce a second output.

6. The system of claim 5, wherein the operations further comprise:
comparing the first output against the second output, wherein the performing the action is further based on the comparing.

7. The system of claim 6, wherein the operations further comprise:
determining that a difference between the first output and the second output is below a threshold; and
calculating a merged output value based on the first output and the second output, wherein the performing the action is further based on the merged output value.

8. A method, comprising:
receiving a transaction request;
requesting, by one or more hardware processors, attribute values corresponding to a set of attributes and associated with the transaction request for use in a machine learning model;
subsequent to the requesting, determining, by the one or more hardware processors, that a first subset of the attribute values, but not a second subset of the attribute values, is available;
modifying, by the one or more hardware processors, the machine learning model based on the first subset of the attribute values;
providing, by the one or more hardware processors, the first subset of the attribute values as input values to the modified machine learning model, wherein the machine learning model is configured to infer the second subset of the attribute values based on the first subset of the attribute values and to produce a first output based on the first subset of the attribute values and the imputed second subset of the attribute values; and
processing the transaction request based on the first output.

9. The method of claim 8, wherein the modified machine learning model is a first instance of the machine learning model, wherein the method further comprises:
selecting a first portion of the first subset of the attribute values;
providing the first portion of the first subset of the attribute values, but not a second portion of the first subset of the attribute values, to a second instance of the machine learning model, wherein the second instance of the machine learning model is configured to infer the second portion of the first subset of the attribute values and the second subset of the attribute values based on the first portion of the first subset of the attribute values, and to produce a second output; and
determining a difference between the first output and the second output.

10. The method of claim 9, further comprising:
determining that the difference exceeds a threshold; and
withholding the processing the transaction request until one or more attribute values from the second subset of the attribute values are available.

11. The method of claim 10, further comprising:
determining that the one or more attribute values are available;
generating a third instance of the machine learning model by modifying the machine learning model based on an availability of the first subset of the attribute values and the one or more attribute values; and
providing the first subset of the attribute values and the one or more attribute values to the third instance of the machine learning model, wherein the third instance of the machine learning model is configured to infer attribute values in the second subset of the attribute values, except the one or more attribute values, based on the first subset of the attribute values and the one or more attribute values, and to produce a third output, and wherein the transaction request is processed further based on the third output.

12. The method of claim 8, further comprising training the machine learning model using a training data set corresponding to the set of attributes, wherein the training the machine learning model comprises:
selecting different subsets of the training data set corresponding to different subsets of the set of attributes for training the machine learning model.

13. The method of claim 13, wherein the training the machine learning model further comprises:
selecting a first subset of the training data set;
generating a fourth instance of the machine learning model by modifying the machine learning model based on a selection of the first subset of the training data set;
providing the first subset of the training data set to the fourth instance of the machine learning model; and
adjusting parameters of the machine learning model based on an output value obtained from the fourth instance of the machine learning model.

14. The method of claim 8, wherein the machine learning model comprises an artificial neural network that includes a plurality of layers of nodes, wherein the plurality of layers of nodes comprises a plurality of input layers that includes a plurality of input nodes, wherein the modifying the machine learning model comprises:
identifying, from the plurality of input nodes, a set of input nodes corresponding to the first subset of the attribute values; and
removing backward connections connected to the set of input nodes.

15. A non-transitory machine-readable medium having stored thereon machine-readable instructions executable to cause a machine to perform operations comprising:
receiving a transaction request;
subsequent to the receiving the transaction request, determining that a first subset of the attribute values, but not a second subset of the attribute values, is available;
modifying a first instance of a machine learning model based on an availability of the first subset of the attribute values;
performing a prediction for the transaction request using the first instance of the machine learning model based on the first subset of the attribute values, wherein the modified first instance of the machine learning model is configured to infer the second subset of the attribute values and to provide a prediction output based on the first subset of the attribute values and the inferred second subset of the attribute values; and
providing the prediction output to a device.

16. The non-transitory machine-readable medium of claim 15, wherein the device is configured to process the transaction request based on the prediction output.

17. The non-transitory machine-readable medium of claim 15, wherein the machine learning model comprises an artificial neural network that includes a plurality of layers of nodes, wherein the plurality of layers of nodes comprises at least a first input layer and a second input layer, wherein the modifying the first instance of the machine learning model comprises:
determining a connection between a first node in the first input layer of the artificial neural network and a second node in the second input layer of the artificial neural network, wherein the second node corresponds to a first attribute value in the first subset of the attribute values, and wherein the first input layer precedes the second input layer in the artificial neural network; and
removing the connection from the first instance of the machine learning model.

18. The non-transitory machine-readable medium of claim 15, wherein the machine learning model comprises an artificial neural network that includes a plurality of layers of nodes, wherein the plurality of layers of nodes comprises at least a first input layer and a second input layer, and wherein the operations further comprise:
providing a first portion of the first subset of the attribute values that corresponds to input nodes in the first input layer of the artificial neural network as input values to a second instance of the machine learning model, wherein the second instance of the machine learning model is configured to infer a second portion of the first subset of the attribute values and the second subset of the attribute values based on the first portion of the first subset of the attribute values, and to produce a second output.

19. The non-transitory machine-readable medium of claim 18, wherein the operations further comprise:
comparing the prediction output against the second output, wherein the processing the request is further based on the comparing.

20. The non-transitory machine-readable medium of claim 19, wherein the operations further comprise:
determining that a difference between the prediction output and the second output is below a threshold;
calculating a merged output value based on the prediction output and the second output; and
providing the merged output value to the device.
